(19) United States
(12) Patent Application Publication
(10) Pub. No.: US 2020/0070699 A1
(43) Pub. Date: Mar. 5, 2020

(54) VEHICLE SEAT AND METHOD OF MANUFACTURING VEHICLE SEAT

(71) Applicant: TACHI-S ENGINEERING U.S.A., INCORPORATED, Farmington Hills, MI (US)

(72) Inventors: Yasuo KAKISHIMA, Farmington Hills, MI (US); Richard Entrup, Farmington Hills, MI (US); Samruddh Kulkarni, Farmington Hills, MI (US)

(21) Appl. No.: 16/117,129

(22) Filed: Aug. 30, 2018

(51) Int. Cl. B60N 2/72; B60N 2/68; B60N 2/50; B60N 2/70

(52) U.S. Cl. CPC B60N 2/72; B60N 2/7017; B60N 2/503; B60N 2/686

(57) ABSTRACT

A vehicle seat is provided with: a seat cushion frame; a seat back frame; a seat cushion main part that is fitted to the seat cushion frame; a seat cushion side part that is arranged on a side portion of the seat cushion main part and that is fitted to the seat cushion frame; a seat back main part that is fitted to the seat back frame; and a seat back side part that is arranged on a side portion of the seat back main part and that is fitted to the seat back frame. Here, each of the seat cushion main part and the seat back main part is composed of a plurality of segments, and each segment has a foam part, and the foam part is separated from the foam part of the other segment.

### BACKGROUND

The present disclosure relates to a vehicle seat and can be applied to, for example, a vehicle seat formed in a divided manner.

In some vehicle seats, a main part and a side part of a seat cushion and a seat back are formed in a divided manner and are mounted on a seat frame in a joined manner, whereby a seat is formed (for example, JPA 8-24068).

### SUMMARY

An object of the present disclosure is to provide a vehicle seat in which a main part of a seat cushion and a seat back on which one occupant is seated is formed in a divided manner.

Other objects and a new feature will be made clear by descriptions and accompanying drawings of the present disclosure.

Brief description of a summary of representatives in this disclosure is as follows.

That is to say, a vehicle seat is provided with: a seat cushion frame; a seat back frame; a seat cushion main part that is fitted to the seat cushion frame; a seat cushion side part that is arranged on a side portion of the seat cushion main part and that is fitted to the seat cushion frame; a seat back main part that is fitted to the seat back frame; and a seat back side part that is arranged on a side portion of the seat back main part and that is fitted to the seat back frame. Here, each of the seat cushion main part and the seat back main part is composed of a plurality of segments, and each segment has a foam part, and the foam part is separated from the foam part of the other segment.

### BRIEF DESCRIPTION OF THE DRAWINGS

FIG. 1 is a figure to illustrate a vehicle seat of a first embodiment;

FIG. 2 is a figure to show a state where some segments are fitted to a seat frame shown in FIG. 1;

FIG. 3 is a figure to show a structure of a right segment shown in FIG. 2;

FIG. 4 is a section view corresponding to an A-A section shown in FIG. 2;

FIG. 5 is a left side view of a vehicle seat of a second embodiment;

FIG. 6 is a perspective side view of a seat cushion of the vehicle seat shown in FIG. 5;

FIG. 7 is a side view of a main part of the seat cushion shown in FIG. 6;

FIG. 8 is a top view of the seat cushion of the vehicle seat shown in FIG. 5;

FIG. 9 is a section view along a B-B line shown in FIG. 8;

FIG. 10 is a section view along a C-C line shown in FIG. 8;

FIG. 11 is a perspective side view of a seat back of the vehicle seat shown in FIG. 5;

FIG. 12 is a front view of the seat back of the vehicle seat shown in FIG. 5;

FIG. 13 is a section view along a D-D line shown in FIG. 12;

FIG. 14 is a section view along an E-E line shown in FIG. 12;

FIG. 15 is a section view along an F-F line shown in FIG. 12;

FIG. 16 is a section view along a G-G line shown in FIG. 12;

FIG. 17 is a perspective view of a vehicle seat of a third embodiment;

FIG. 18 is a perspective view of a seat frame of the vehicle seat shown in FIG. 17;

FIG. 19 is a perspective view of a segment of a seat back of the vehicle seat shown in FIG. 17;

FIG. 20 is a perspective view of a seat back frame of the vehicle seat shown in FIG. 17;

FIG. 21A is a perspective view of a right segment of a side part of the seat back of the vehicle seat shown in FIG. 17;

FIG. 21B is a perspective view of a hard panel of a right side part shown in FIG. 21A;

FIG. 22A is a figure to illustrate a way to fix a right assisting bracket and a right segment;

FIG. 22B is a figure to illustrate a way to fix a right assisting bracket, a right segment, and an upper segment;

FIG. 22B is a figure to illustrate a way to fix a right assisting bracket, a right segment, and an upper segment;

FIG. 22C is a figure to illustrate a way to fix a right assisting bracket, a right segment, and a central segment;

FIG. 23A is a perspective view of a front side of an upper segment of the seat back;

FIG. 23B is a perspective view of a rear side of the upper segment of the seat back;

FIG. 23C is a perspective view of a rear side of a hard panel of the upper segment of the seat back;

FIG. 24A is a perspective view of a front side of a central segment of the seat back;

FIG. 24B is a perspective view of a rear side of the central segment of the seat back;

FIG. 25A is a perspective view of a front side of a lower segment of the seat back;

FIG. 25B is a perspective view of a rear side of the lower segment of the seat back;

FIG. 26 is a figure to illustrate a way to fit the lower segment to the seat back frame;

FIG. 27 is a perspective view of a segment of a seat cushion of the vehicle seat shown in FIG. 17;

FIG. 28 is a perspective view of a seat cushion frame of the vehicle seat shown in FIG. 17;

FIG. 29A is a perspective view of a hard panel of a right segment of a side part of the seat cushion of the vehicle seat shown in FIG. 17;

FIG. 29B is a perspective view of a hard panel of a left segment of the side part of the seat cushion of the vehicle seat shown in FIG. 17;

FIG. 30A is a figure to illustrate a way to fix a right assisting bracket and a right segment;

FIG. 30B is a figure to illustrate a way to fix the right assisting bracket and the right segment;

FIG. 30C is a figure to illustrate a way to fix a left assisting bracket and a left segment;

FIG. 31A is a perspective view of a front side of a rear segment of the seat cushion;

FIG. 31B is a perspective view of a rear side of the rear segment of the seat cushion;

FIG. 32 is a figure to illustrate a way to fit the rear segment to the seat cushion frame;

FIG. 33A is a perspective view of a front side of the central segment of the seat cushion;

FIG. 33B is a perspective view of a rear side of the central segment of the seat cushion;

FIG. 34 is a figure to illustrate a way to fit the central segment to the seat cushion frame;

FIG. 35 is a figure to illustrate a way to fix the central segment and a metal pan;

FIG. 36A is a perspective view of a front side of a front segment of the seat cushion;

FIG. 36B is a perspective view of a rear side of a hard panel of the front segment of the seat cushion;

FIG. 37 is a figure to illustrate a way to fit the front segment to the seat cushion frame;

FIG. 38 is a perspective view of a child booster segment; and

FIG. 39 is a perspective view of a vehicle seat in which a child booster segment is embedded.

### DESCRIPTION OF THE PREFERRED EMBODIMENTS

Hereinafter, some of typical embodiments will be described with reference to the drawings. However, in the following description, the same constituent elements are denoted by the same reference symbols and their duplicate descriptions will be omitted in some cases.

Further, a part of the embodiment and all or a part of a plurality of embodiments can be applied compositely as appropriate within a technically consistent range. In this regard, in some figures, in order to more clarify a description, a width, a thickness, and a shape of each part will be illustrated schematically as compared with an actual embodiment but this is just an example, and the figures do not limit an interpretation of the present invention.

In this regard, in the following descriptions, a case where a vehicle mounted with a vehicle seat is placed on a horizontal plane is made as a base and a vertical direction is defined as an up and down direction (UW, DW). Further, a front and rear direction (FR, RR) is defined in such a way as to match a longitudinal direction of the vehicle, and a left and right direction (width direction) is defined in such a way as to match a width direction of the vehicle. An FR is a front direction of the vehicle and an RR is a rear direction of the vehicle. Further, at the time of describing the vehicle seat, a side when the vehicle is viewed from a rear side will be referred to as a right side (RH) or a left side (LH).

### First Embodiment

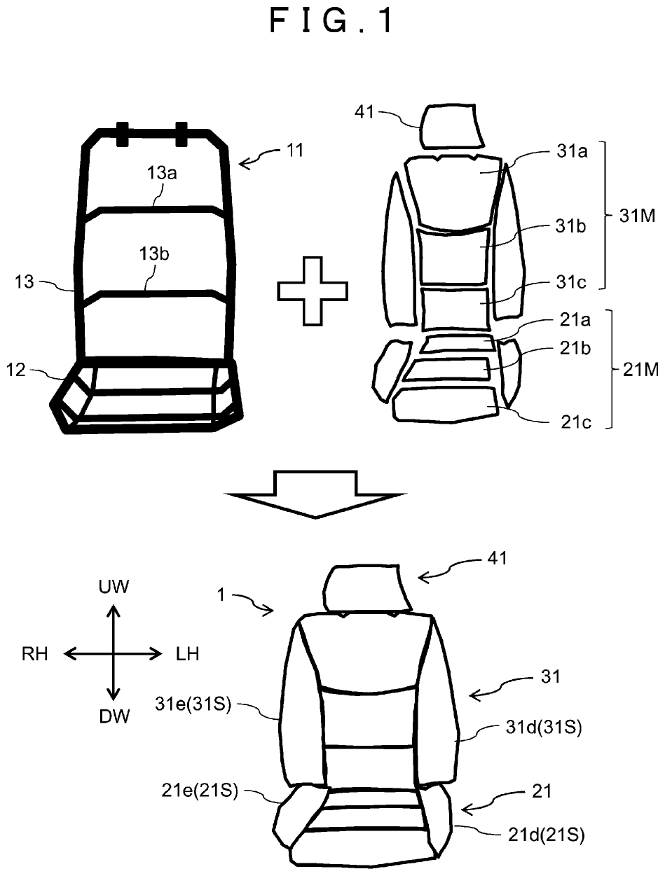

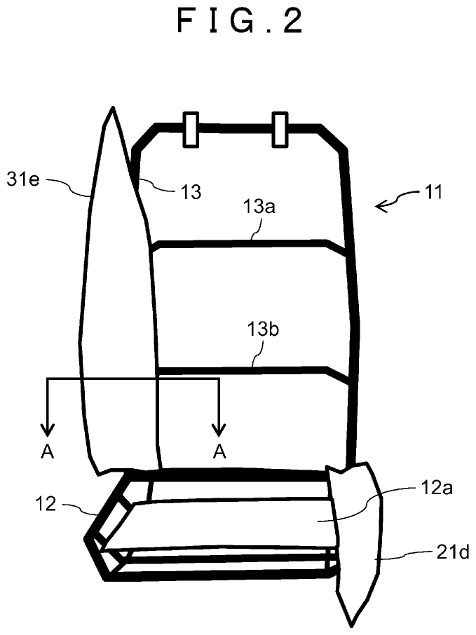

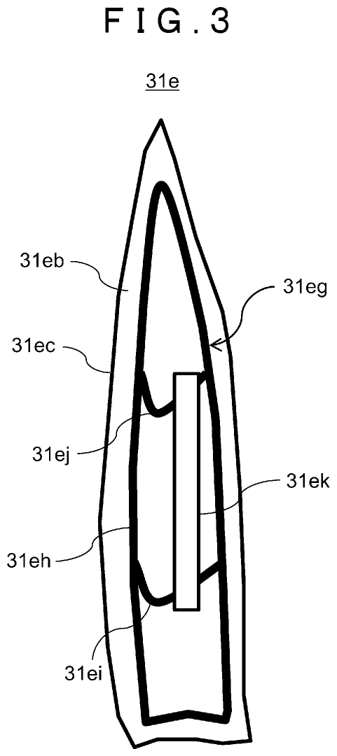

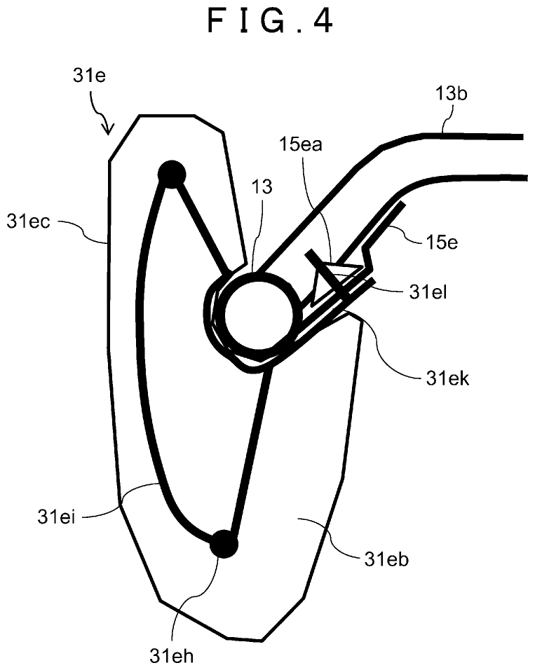

FIG. 1 is a figure to illustrate a vehicle seat of a first embodiment. FIG. 2 is a figure to show a state where a portion of a segment is fitted to a seat frame shown in FIG. 1. FIG. 3 is a figure to show a structure of a right segment shown in FIG. 2. FIG. 4 is a section view corresponding to an A-A section shown in FIG. 2.

As shown in FIG. 1, a seat frame 11 is provided with a seat cushion frame 12 formed of a metal pipe or the like and a seat back frame 13 formed of a metal pipe or the like. The seat back frame 13 has assisting frames 13a, 13b fixedly attached thereto, the assisting frames 13a, 13b fixing respective segments of a divided seat back 31.

The seat cushion 21 is composed of a main part 21M and a side part 21S arranged on both sides of the main part 21M. The main part 21M is composed of a rear segment 21a, a central segment 21b, and a front segment 21c, and the side part 21S is composed of a left segment 21d and a right segment 21e. The seat back 31 is composed of a main part 31M and a side part 31S arranged on both sides of the main part 31M. The main part 31M is composed of an upper segment 31a, a central segment 31b, and a lower segment 31c, and the side part 31S is composed of a left segment 31d and a right segment 31e.

To the seat cushion frame 12 are fitted the rear segment 21a, the central segment 21b, the front segment 21c, the left segment 21d, and the right segment 21e, which are divided segments of the seat cushion 21. To the seat back frame 13 are fitted the upper segment 31a, the central segment 31b, the lower segment 31c, the left segment 31d, and the right segment 31e, which are divided segments of the seat back 31. To the seat back frame 13 is fitted a head rest 41. In this way, the vehicle seat 1 is composed of these segments.

The rear segment 21a, the central segment 21b, the front segment 21c, the left segment 21d, the right segment 21e, the upper segment 31a, the central segment 31b, the lower segment 31c, the left segment 31d, the right segment 31e, and the head rest 41 are composed of a urethane foam, a trim cover, and the like. The urethane foam and the trim cover are referred to as a foam part.

As shown in FIG. 2, the right segment 31e of the side part 31S of the seat back 31 is fitted to the seat back frame 13 and to the assisting frames 13a, 13b which connect left and right sides of the seat back frame 13.

As shown in FIG. 3, the right segment 31e is composed of a sub-frame 31eg, a fitting part 31ek, a urethane foam 31eb, and a trim cover 31ec. The sub-frame 31eg has a longitudinal sub-frame part 31eh and lateral sub-frames 31ei, 31ej.

As shown in FIG. 4, in the segment 31e, a stud 31el of the fitting part 31ek is inserted into a nut 15ea of a fitting part 15e of the assisting frame 13b and other stud (not shown in the figure) of the fitting part 31ek is inserted into a nut of a fitting part (not shown in the figure) of the assisting frame 13a, whereby the segment 31e is fitted to the seat back frame 13. The other segments are fitted to the seat frame 11 in the same way.

### Second Embodiment

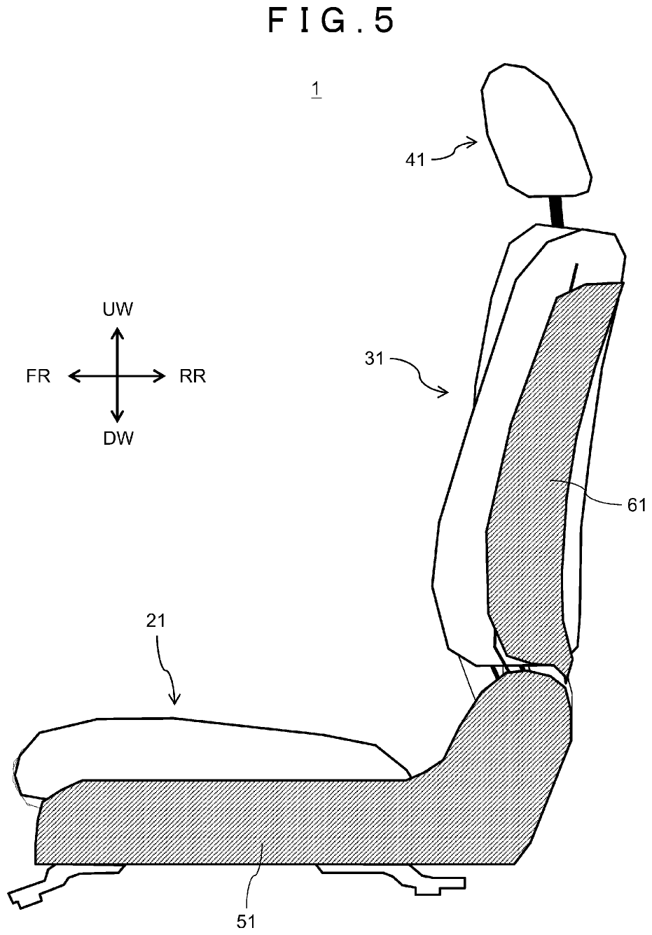

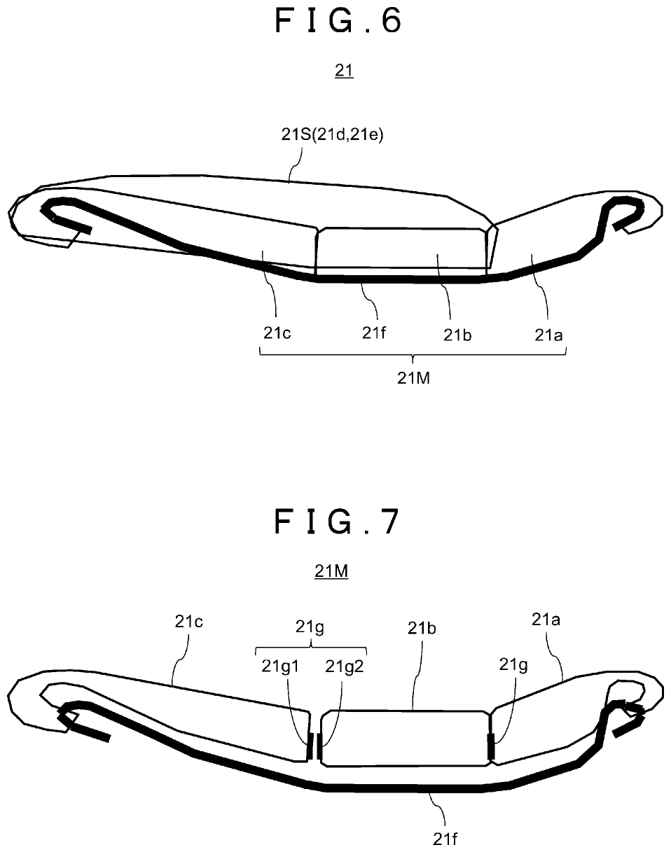

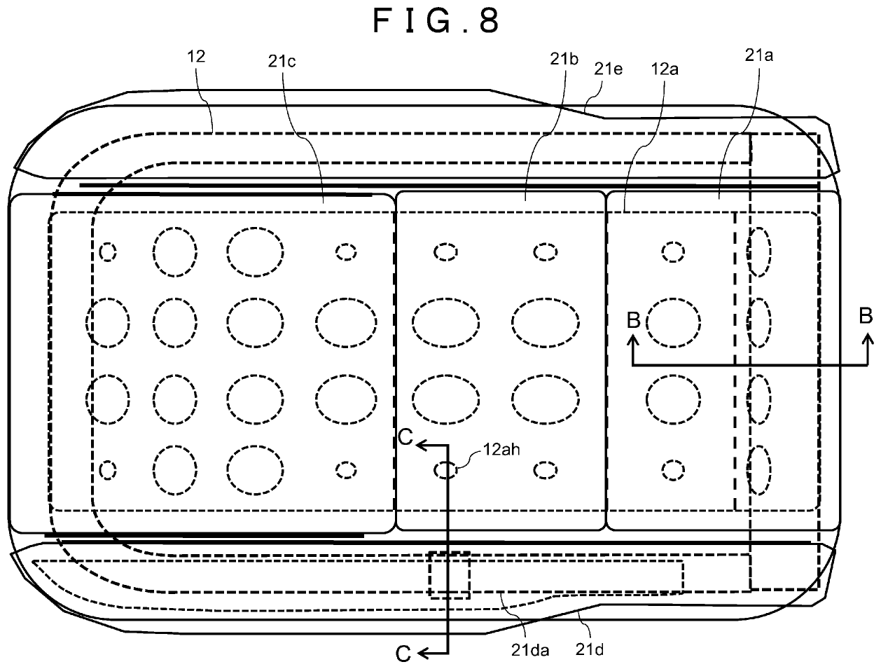

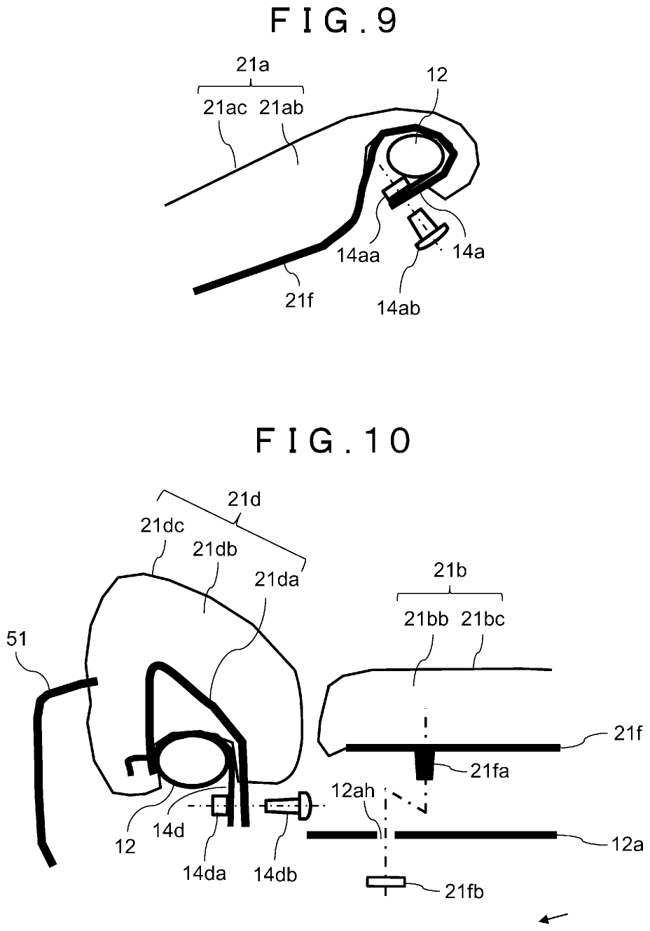

FIG. 5 is a left side view of a vehicle seat of a second embodiment. FIG. 6 is a perspective side view of a seat cushion of the vehicle seat shown in FIG. 5. FIG. 7 is a side view of a main part of the seat cushion shown in FIG. 6. FIG. 8 is a top view of the seat cushion of the vehicle seat shown in FIG. 5. FIG. 9 is a section view along a line B-B shown in FIG. 8. FIG. 10 is a section view along a line C-C shown in FIG. 8.

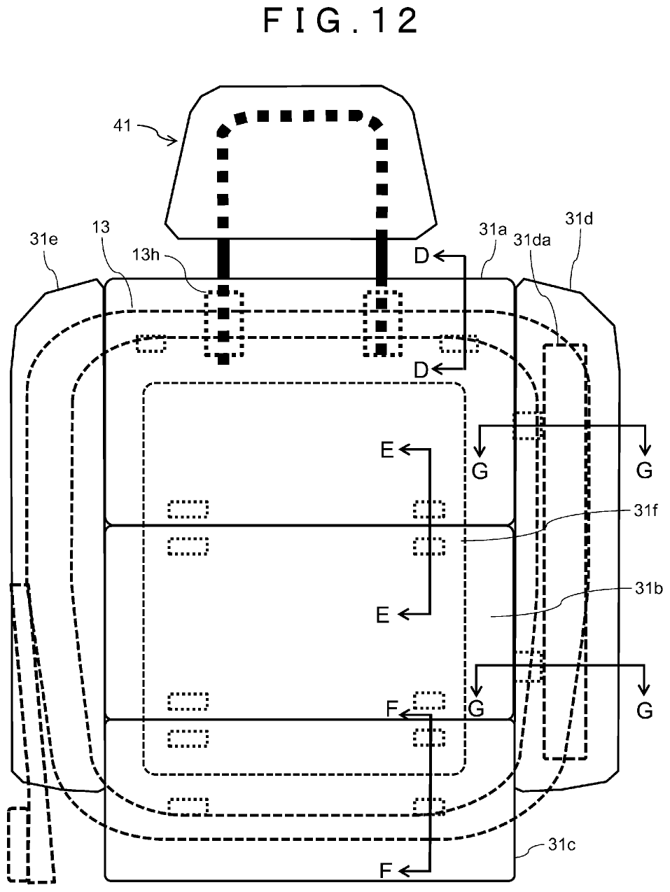

As shown in FIG. 5, the vehicle seat 1 of the second embodiment is provided with a seat cushion 21, a seat back 31, a head rest 41, a side cover 51, and a back board 61. The vehicle seat 1 is provided with a seat cushion frame 12 (see FIG. 8) and a seat back frame (see FIG. 12).

As shown in FIG. 6, the seat cushion 21 is composed of a main part 21M and a side part 21S. The main part 21M is composed of a rear segment 21a, a central segment 21b, a front segment 21c, and a hard panel 21f formed of plastic or the like. The side part 21S is composed of a left segment 21d and a right segment 21e.

As shown in FIG. 7, the central segment 21b and the front segment 21c are fixed by a bonding cloth 21g made of a pile-shaped fabric 21g1 and a hook-shaped fabric 21g2 which are made of nylon and bonded to each other. In this regard, the bonding cloth 21g made of nylon is set as required so as to mainly enhance a sense of unity between the central segment 21b and the front segment 21c to thereby improve a ride quality, so the central segment 21b and the front segment 21c do not necessarily need to be fixed to each other by the bonding cloth 21g made of nylon. The rear segment 21a and the central segment 21b are also fixed to each other in the same way. The rear segment 21a, the central segment 21b, and the front segment 21c are mounted on a hard panel 21f.

As shown in FIG. 8, the seat cushion frame 12 has a metal pan 12a fixedly attached thereto, the metal pan 12a having a plurality of holes 12ah. The rear segment 21a, the central segment 21b, and the front segment 21c of the main part 21M are fitted to the seat cushion frame 12 and the metal pan 12a via the hard panel 21f. The segment 21d and the segment 21e of the side part 21S are fitted to seat cushion frame 12.

As shown in FIG. 9, the seat cushion frame 12 has an assisting bracket 14a fixedly attached thereto, the assisting bracket 14a fitting the hard panel 21f of the rear segment 21a to the seat cushion frame 12. The hard panel 21f is fitted to the seat cushion frame 12 by a nut 14aa fixed to the assisting bracket 14a and by a bolt 14ab. The rear segment 21a is formed of a urethane foam 21ab and a trim cover 21ac. The urethane foam 21ab and the trim cover 21ac are referred to as a foam part. The front segment 21c has the same structure as the rear segment 21a.

As shown in FIG. 10, the hard panel 21f has a plastic stud 21fa and the hard panel 21f is fixed to the metal pan 12a by the plastic stud 21fa and a speed nut 21fb. The central segment 21b of the main part 21M is formed of a urethane foam 21bb and a trim cover 21bc.

As shown in FIG. 10, the left segment 21d of the side part 21S is formed of a hard panel 21da made of plastic or metal, a urethane foam 21db, and a trim cover 21dc. The seat cushion frame 12 has an assisting bracket 12c fixedly attached thereto, the assisting bracket 12c fitting the hard panel 21da of the left segment 21d to the seat cushion frame 12, and the hard panel 21da is fixed to the seat cushion frame 12 by a nut 12ca fixedly attached to the assisting bracket 12c and by a bolt 12cb. The right segment 21e has the same structure as the left segment 21d and is fifed to the seat cushion frame 12 in the same way.

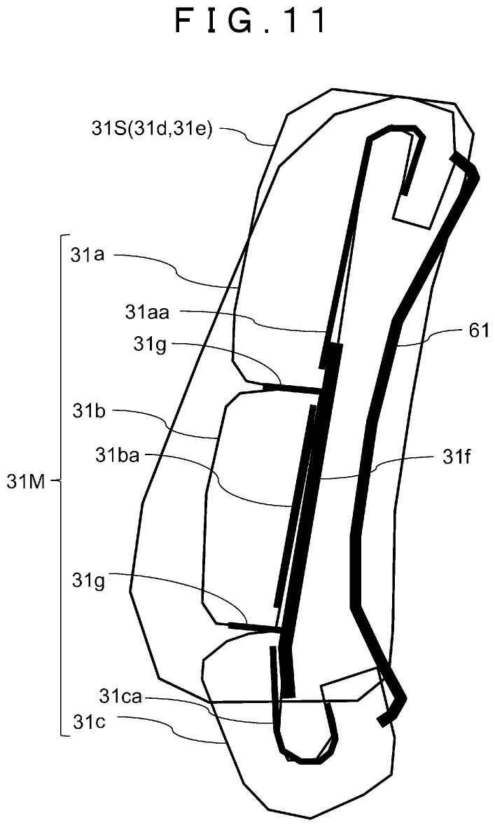

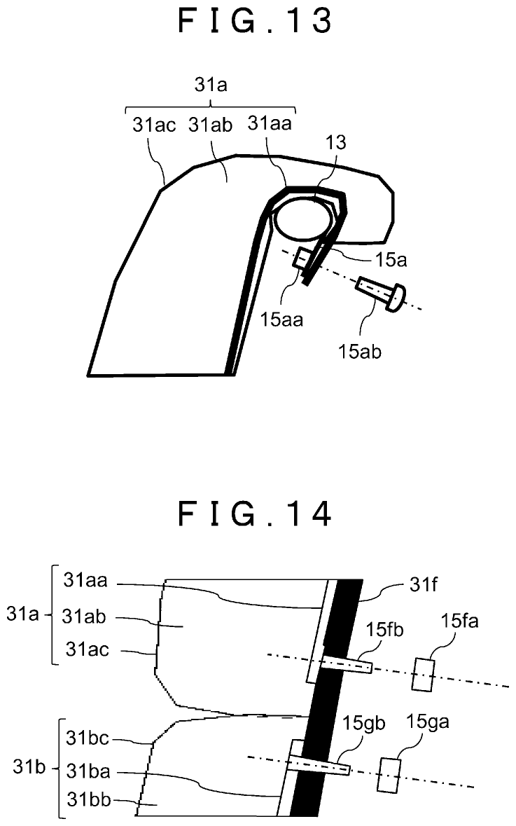

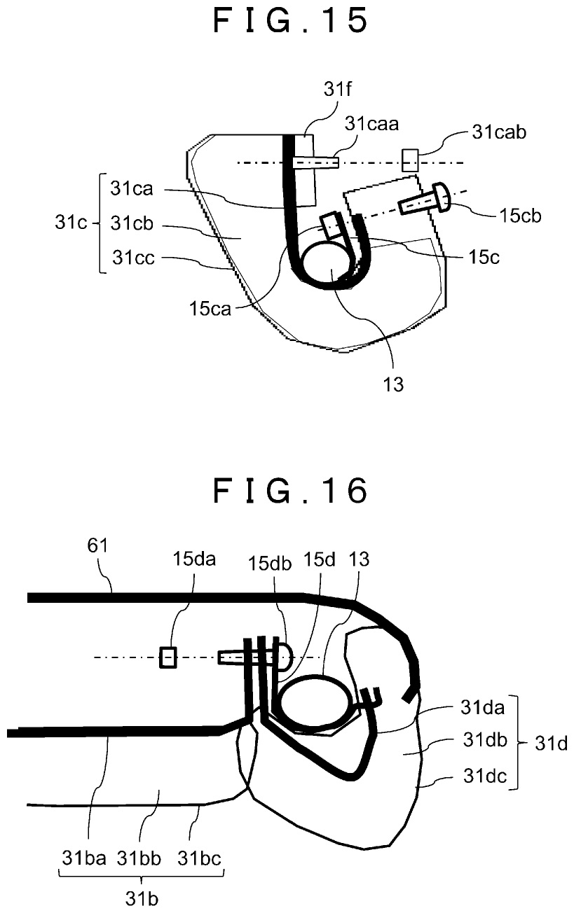

FIG. 11 is a perspective side view of a seat back of the vehicle seat shown in FIG. 5. FIG. 12 is a front view of the seat back of the vehicle seat shown in FIG. 5. FIG. 13 is a section view along a line D-D shown in FIG. 12. FIG. 14 is a section view along a line E-E shown in FIG. 12. FIG. 15 is a section view along a line F-F shown in FIG. 12. FIG. 16 is a section view along a line G-G shown in FIG. 12.

As shown in FIG. 11, the seat back 31 is composed of a main part 31M and a side part 31S. The main part 31M is composed of an upper segment 31a, a central segment 31b, a lower segment 31c, and a suspension mat 31f. The side part 31S is composed of a left segment 31d and a right segment 31e. The upper segment 31a, the central segment 31b, and the lower segment 31c are respectively provided with hard panels 31aa, 31ba, 31ca, which are formed of plastic or the like. The central segment 31b and the lower segment 31c are fixed by a bonding cloth 31g made of a pile-shaped fabric and a hook-shaped fabric which are made of nylon and bonded to each other. The upper segment 31a and the central segment 31b are fixed in the same way. The upper segment 31a, the central segment 31b, and the lower segment 31c are mounted on the suspension mat 31f.

As shown in FIG. 12, the seat back frame 13 has a head rest fitting part 13h fixedly attached thereto, the head rest fitting part 13h fitting the head rest 41 to the seat back frame 13. The upper segment 31a, the central segment 31b, and the lower segment 31c are fitted to the seat back frame 13. The left segment 31d and the right segment 31e of the side part 31S are fitted to the seat back frame 13. The head rest 41 is fitted to the seat back frame 13.

As shown in FIG. 13, the seat back frame 13 has an assisting bracket 15a fixed thereto, the assisting bracket 15a fitting the hard panel 31aa of the upper segment 31a to the seat back frame 13. The hard panel 31aa is fixed to the seat back frame 13 by a nut 15aa fixedly attached to the assisting bracket 15a and by a bolt 15ab. In the upper segment 31a of the main part 21M, the hard panel 31aa, a urethane pad 31ab, and a trim cover 31ac are molded by an integral foam molding or the like.

As shown in FIG. 14, the hard panel 31aa has a plastic stud 15fb and is fixed to the suspension mat 31f by the plastic stud 15fb and a speed nut 15fa. The plastic stud 15fb and the hard panel 31aa are integrally molded. The hard panel 31ba has a plastic stud 15gb and is fixed to the suspension mat 31f by the plastic stud 15fb and the speed nut 15fa. The plastic stud 15fb is molded integrally with the hard panel 31aa. The hard panel 31ba has a plastic stud 15gb and is fixed to the suspension mat 31f by the plastic stud 15gb and a speed nut 15ga. The plastic stud 15gb is molded integrally with the hard panel 31ba. In the central segment 31b of the main part 21M, the hard panel 31ba, a urethane foam 31bb, and a trim cover 31bc are molded by the integral foam molding or the like.

As shown in FIG. 15, the seat back frame 13 has an assisting bracket 15c fixed thereto, the assisting bracket 15c fitting the hard panel 31ca of the lower segment 31c to the seat back frame 13. The hard panel 31ca is fixed to the seat back frame 13 by a nut 15ca fixedly attached to the assisting bracket 15c and by a bolt 15cb. In the lower segment 31c of the main part 21M, the hard panel 31ca, a urethane pad 31cb, and a trim cover 31cc are molded by an integral foam molding or the like.

As shown in FIG. 16, the left segment 31d of the side part 31S is formed of a hard panel 31da made of plastic or metal, a urethane pad 31db, and a trim cover 31dc. The seat back frame 13 has an assisting bracket 15d fixed thereto, the assisting bracket 15d fitting the hard panels 31ba, 31d to the seat back frame 13, and the hard panels 31ba, 31da are fixed to the seat back frame 13 by a nut 15da and a stud 15db.

### Third Embodiment

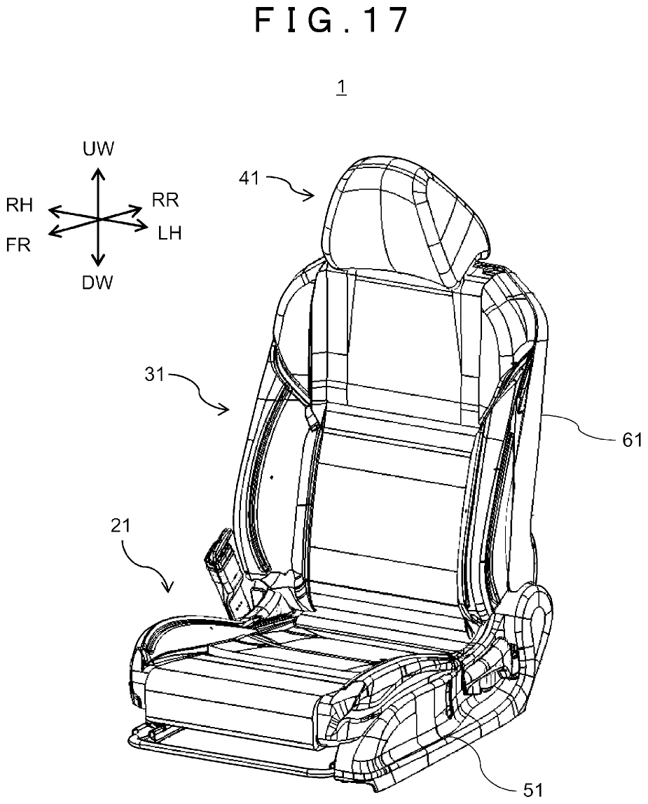

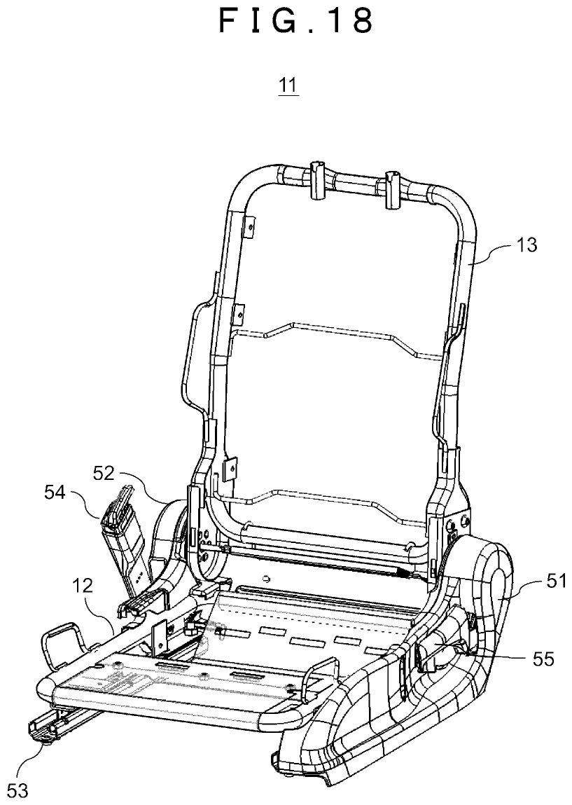

Firstly, a structure of a vehicle seat of a third embodiment will be described by the use of FIGS. 17, 18. FIG. 17 is a perspective view of the vehicle seat of the third embodiment. FIG. 18 is a perspective view of a seat frame of the vehicle seat shown in FIG. 17.

As shown in FIG. 17, a vehicle seat 1 of the third embodiment is provided with a seat cushion 21 composed of a plurality of segments, a seat back 31 composed of a plurality of segments, a head rest 41, a side cover 51, and a back board 61.

As shown in FIG. 18, a seat frame 11 is provided with a seat cushion frame 12, a seat back frame 13, a left side cover 51, a right side cover 52, a seat slide mechanism 53, and a buckle 54.

Next, an outline of a seat back side will be described by the use of FIGS. 19, 20. FIG. 19 is a perspective view of a segment of the seat back of the vehicle seat shown in FIG. 17. FIG. 20 is a perspective view of the seat back frame of the vehicle seat shown in FIG. 17.

As shown in FIG. 19, the seat back 31 is provided with a left segment 31d and a right segment 31e of a main part and a side part. The main part is composed of three divided parts of an upper segment 31a, a central segment 31b, and a lower segment 31c. The seat back 31 has a head rest 41 fitted thereto via head rest guides 42a, 42b.

As shown in FIG. 20, the seat back frame 13 is formed of, for example, a metal pipe and has upper brackets 13d, 13e, head rest fitting parts 13h, 13i, segment hook wires 17a, 17b, a segment snap wire 17c, segment assisting brackets 17d, 17e, 17f, 17g, 17h, and side part assisting wires 17j, 17k fixedly attached thereto. The upper brackets 13d, 13e are fitted to the lower brackets 13g, 13f connected to the seat cushion frame 12. In this regard, a back of the upper bracket 13e is also fitted with a segment assisting bracket 17i which is not shown in the figure.

The segment hook wires 17a, 17b are used for fitting the central segment 31b and the lower segment 31c, respectively, and the segment snap wire 17c is used for fitting the lower segment 31c. The segment assisting bracket 17d is used for fitting the right segment 31e, and the segment assisting bracket 17f is used for fitting the right segment 31e and the upper segment 31a, and the segment assisting bracket 17h is used for fitting the right segment 31e and the central segment 31b, and the segment assisting bracket 17e is used for fitting the left segment 31d, and the segment assisting bracket 17g is used for fitting the left segment 31d and the upper segment 31a, and the segment assisting bracket 17h is used for fitting the left segment 31d and the central segment 31b.

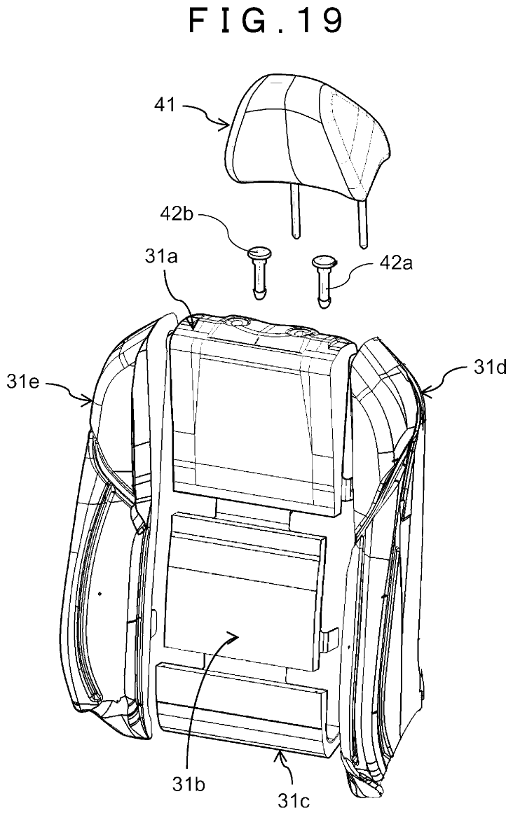

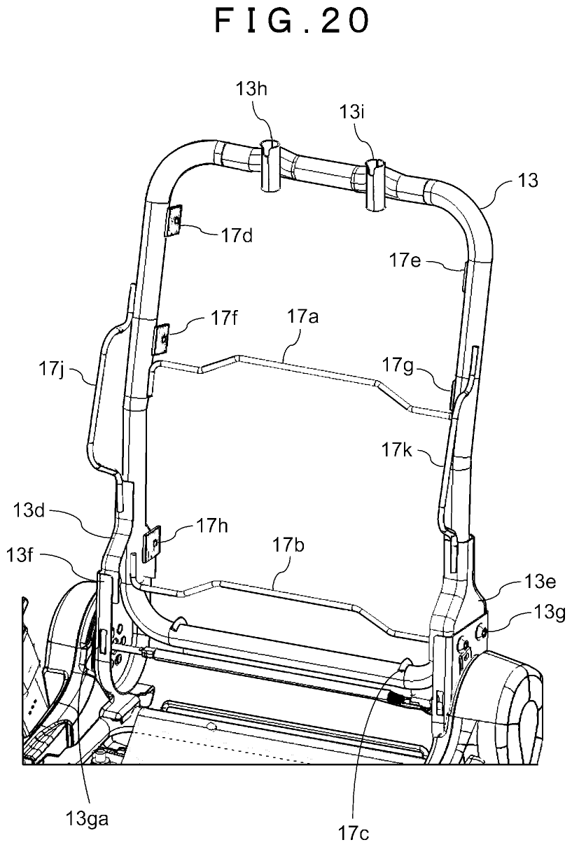

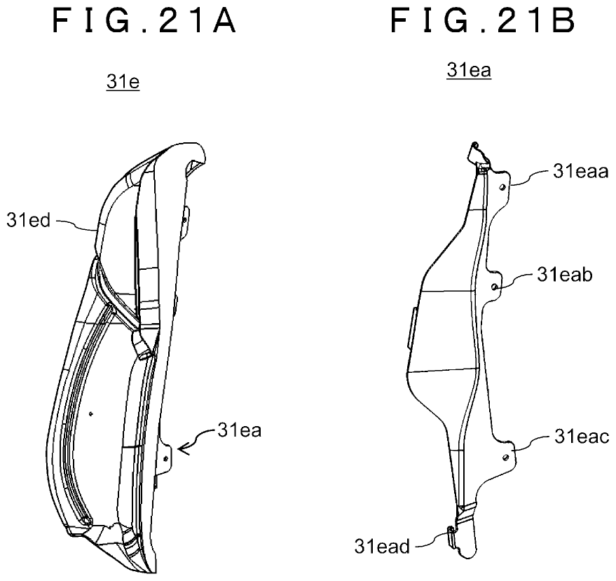

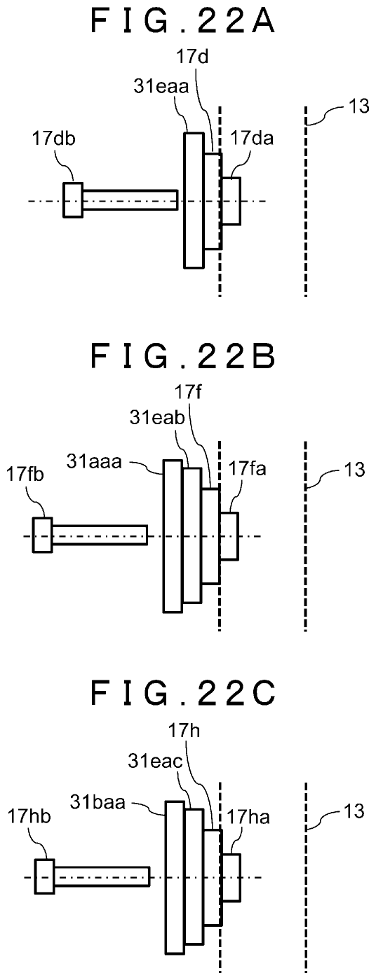

Next, a side part of the seat back will be described by the use of FIGS. 21A, 21B, 22A, 22B, and 22C. FIG. 21A is a perspective view of a right segment of the side part of the seat back of the vehicle seat shown in FIG. 17. FIG. 21B is a perspective view of a hard panel of a right segment shown in FIG. 21A. FIG. 22A is a figure to illustrate a way to fix the right assisting bracket to the right segment. FIG. 22B is a figure to illustrate a way to fix the right assisting bracket to the right segment and the upper segment. FIG. 22C is a figure to illustrate a way to fix the right assisting bracket to the right segment and the central segment.

As shown in FIG. 21A, the right segment 31e is composed of a hard panel 31ea formed of plastic and a foam part 31ed. The foam part 31ed is formed by pouring foam on the hard panel 31ea. The foam part 31ed may be formed by fitting a part formed of the urethane foam and the trim cover to the hard panel. As shown in FIG. 21B, the hard panel 31ea has fitting parts 31eaa, 31eab, 31eac integrally formed with its main body. As shown in FIG. 22A, the fitting part 31eaa is fixed to the seat back frame 13 by a nut 17da fixedly attached to the segment assisting bracket 17d and by a bolt 17db. Further, as shown in FIG. 22B, the fitting part 31eab is fixed to the seat back frame 13 by a nut 17fa fixedly attached to the segment assisting bracket 17f and by a bolt 17fb. Still further, as shown in FIG. 22C, the fitting part 31eac is fixed to the seat back frame 13 by a nut 17ha fixedly attached to the segment assisting bracket 17h and by a bolt 17hb. The left segment 31d has the same structure as the right segment 31e and is fixed to the seat back frame 13 in the same way as the right segment 31e.

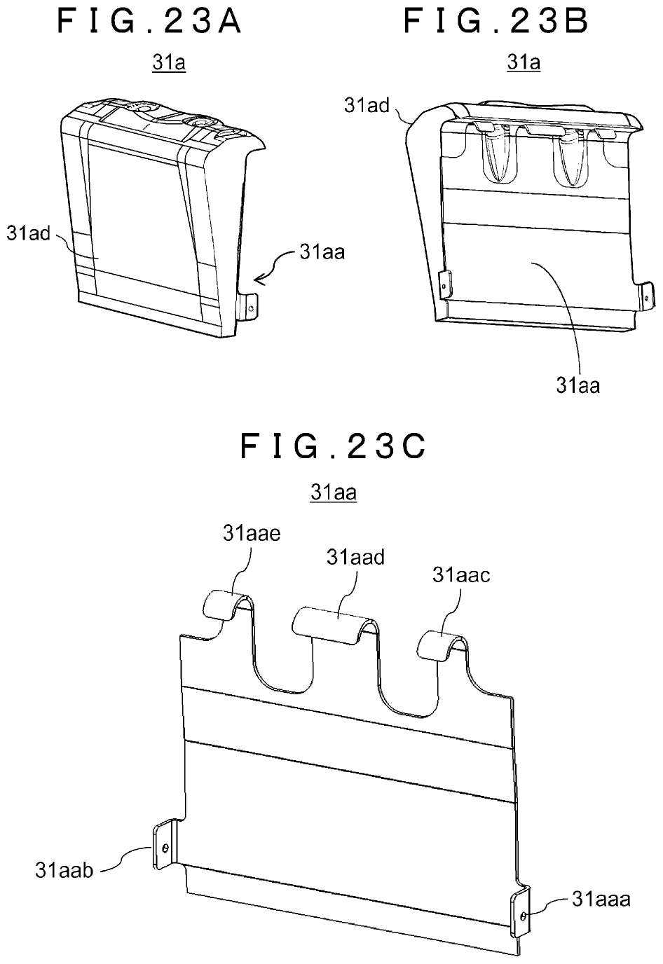

Next, an upper segment of the seat back will be described by the use of FIGS. 22B, 23A, 23B, and 23C. FIG. 23A is a perspective view of a front side of the upper segment of the seat back. FIG. 23B is a perspective view of a rear side of the upper segment of the seat back. FIG. 23C is a perspective view of a rear side of the hard panel of the upper segment of the seat back.

As shown in FIGS. 23A, 23B, the upper segment 31a is composed of a hard panel 31aa formed of plastic and a foam part 31ad. The foam part 31ad is formed in the same way as the foam part 31ed. As shown in FIG. 23C, the hard panel 31aa has fitting parts 31aaa, 31aab and hook parts 31aac, 31aad, 31aae which are formed integrally with its main body. The hook parts 31aac, 31aad, 31aae are engaged with an upper portion of the seat back frame 13, and as shown in FIG. 22B, the fitting part 31aaa is fixed to the seat back frame 13 together with the fitting part 31eab by the nut 17fa fixedly attached to the segment assisting bracket 17f and by the bolt 17fb. The fitting part 31aab is fixed to the seat back frame 13 in the same way as the fitting part 31aaa.

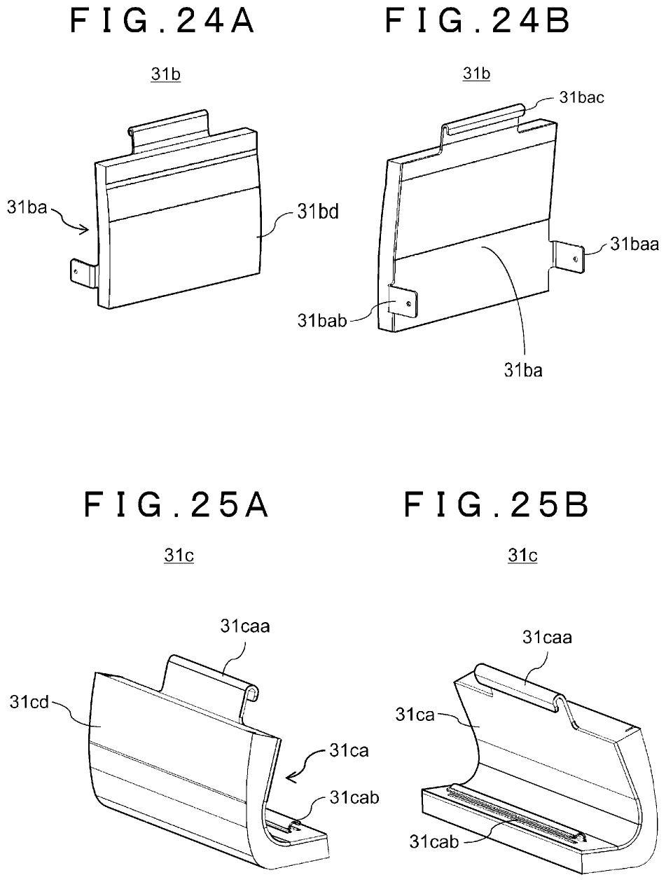

Next, a central segment of the seat back will be described by the use of FIGS. 22C, 24A, 24B. FIG. 24A is a perspective view of a front side of the central segment of the seat back. FIG. 24B is a perspective view of a rear side of the central segment of the seat back.

As shown in FIG. 24A, the central segment 31b is composed of a hard panel 31ba formed of plastic and a foam part 31ad. The foam part 31bd is formed in the same way as the foam part 31bd. As shown in FIG. 24B, the hard panel 31ba has fitting parts 31baa, 31bab and hook parts 31bac which are formed integrally with its main body. The hook parts 31bac is engaged with a segment wire hook 17a, and as shown in FIG. 22C, the fitting part 31baa is fixed to the seat back frame 13 together with the fitting part 31eac by the nut 17ha fixedly attached to the segment assisting bracket 17h and by the bolt 17hb. The fitting part 31bab is fixed to the seat back frame 13 in the same way as the fitting part 31baa.

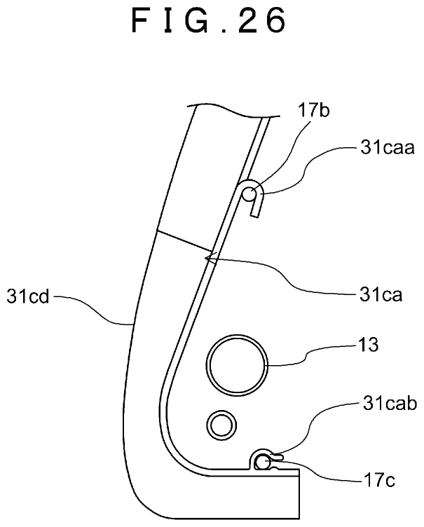

Next, a lower segment of the seat back will be described by the use of FIGS. 25A, 25B, 26. FIG. 25A is a perspective view of a front side of the lower segment of the seat back. FIG. 25B is a perspective view of a rear side of the lower segment of the seat back. FIG. 26 is a figure to illustrate a way to fit the lower segment to the seat back frame.

As shown in FIG. 25A, the lower segment 31c is formed of a hard panel 31ca formed of plastic and a foam part 31cd. The foam part 31cd is formed in the same way as the foam part 31ad. As shown in FIG. 25B, the hard panel 31ca has a hook part 31caa and a snap part 31cab which are formed integrally with its main body. As shown in FIG. 26, the hook part 31caa is engaged with the segment hook wire 17b and the snap part 31cab is fixed to the segment snap wire 17c.

In this regard, the seat back 31 has a back board 61 fitted to a back side thereof.

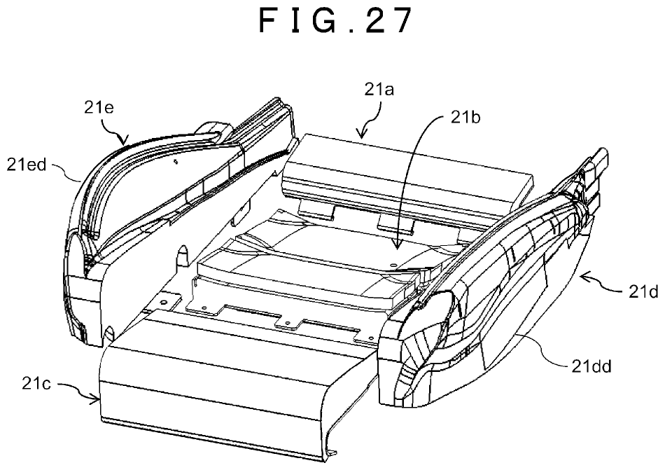

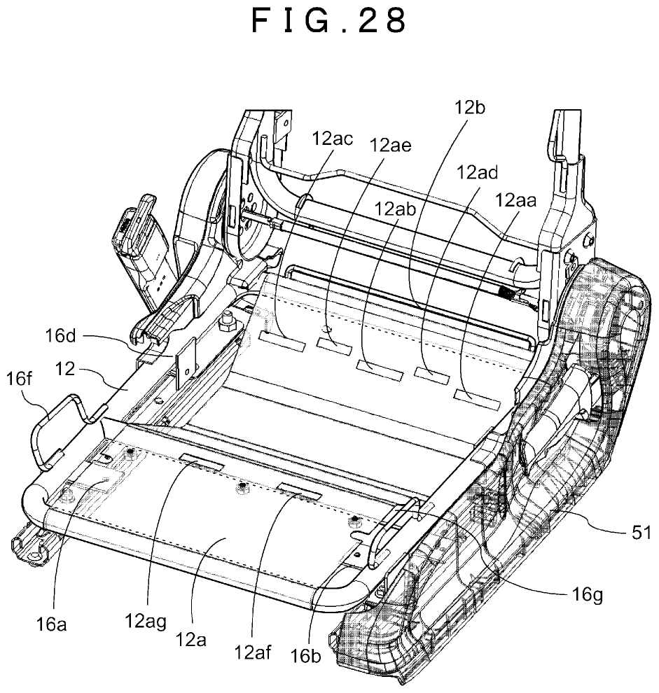

Next, an outline of a seat cushion side will be described by the use of FIGS. 27, 28. FIG. 27 is a perspective view of a segment of a seat cushion of the vehicle seat shown in FIG. 17. FIG. 28 is a perspective view of a seat cushion frame of the vehicle seat shown in FIG. 17.

As shown in FIG. 27, a seat cushion 21 is provided with a left side segment 21d and a right side segment 21e of a main part and a side part. The main part is composed of three divided segments of a rear segment 21a, a central segment 21b, and a front segment 21c.

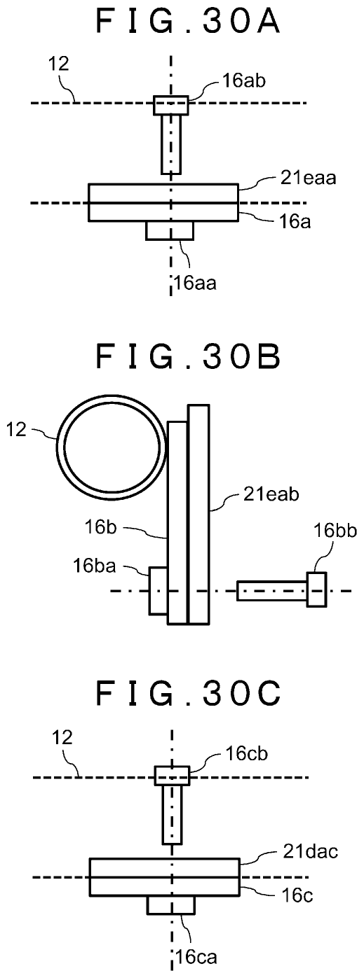

As shown in FIG. 28, the seat cushion frame 12 is formed of, for example, a metal pipe and has a metal pan 12a, a segment assisting wire 12b, segment assisting brackets 16a, 16b, 16d, and side part assisting wires 16f, 16g fixedly attached thereto. In this regard, segment assisting brackets 16c (see FIG. 30C), 16e (not shown in the figure), which are hidden by a side cover 51 and cannot be seen, are fixed to the seat cushion frame 12.

The metal pan 12a has holes 12aa, 12ab, 12ac, 12ad, 12ae, 12ad, 12ae, 12af, 12ag made therein. The holes 12aa, 12ab, 12ac are used for fitting the rear segment 21a. The holes 12ad, 12ae are used for fitting the central segment 21b. The holes 12af, 12ag are used for fitting the front segment 21c.

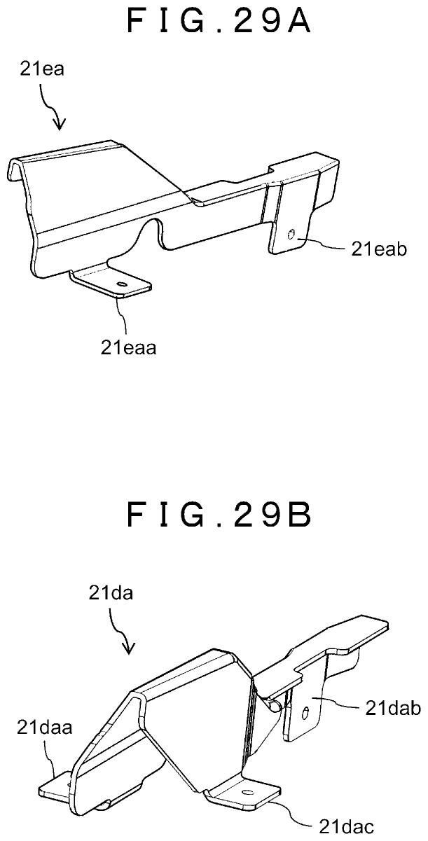

Next, a side part of the seat cushion will be described by the use of FIGS. 29A, 29B, 30A, 30B, 30C. FIG. 29A is a perspective view of a hard panel of a right segment of the side part of the seat cushion of the vehicle seat shown in FIG. 17. FIG. 29B is a perspective view of a hard panel of a left segment of the side part of the seat cushion of the vehicle seat shown in FIG. 17. FIG. 30A is a figure to illustrate a way to fix the right assisting bracket and the right segment. FIG. 30B is a figure to illustrate a way to fix the right assisting bracket, the right segment, and the upper segment. FIG. 30C is a figure to illustrate a way to fix the left assisting bracket and the left segment.

The right segment 21e is composed of a hard panel 21ea formed of plastic and a foam part 21ed. As shown in FIG. 29A, the hard panel 21ea has fitting parts 21eaa, 21eab which are formed integrally with its main body. As shown in FIG. 30A, the fitting part 21eaa is fixed to the seat cushion frame 12 by a nut 16aa fixedly attached to the segment assisting bracket 16a and by a bolt 16ab. Further, as shown in FIG. 30B, the fitting parts 21eab is fixed to the seat cushion frame 12 by a nut 16ba fixedly attached to the segment assisting bracket 16b and by a bolt 16bb.

The left segment 21d is composed of a hard panel 21da formed of plastic and a foam part 21dd. As shown in FIG. 29B, the hard panel 21da has fitting parts 21daa, 21dab, 21dac. The fitting part 21daa is fixed to the seat cushion frame 12 by a nut (not shown in the figure) fixedly attached to the segment assisting bracket 16b and by a bolt (not shown in the figure). The fitting part 21dab is fixed to the seat cushion frame 12 by a nut (not shown in the figure) fixedly attached to the segment assisting bracket 16e and by a bolt (not shown in the figure), as is the case with the fitting part 21eab. As shown in FIG. 30C, the fitting parts 21dac is fixed to the seat cushion frame 12 by a nut 16ca fixedly attached to the segment assisting bracket 16c and by a bolt 16cb.

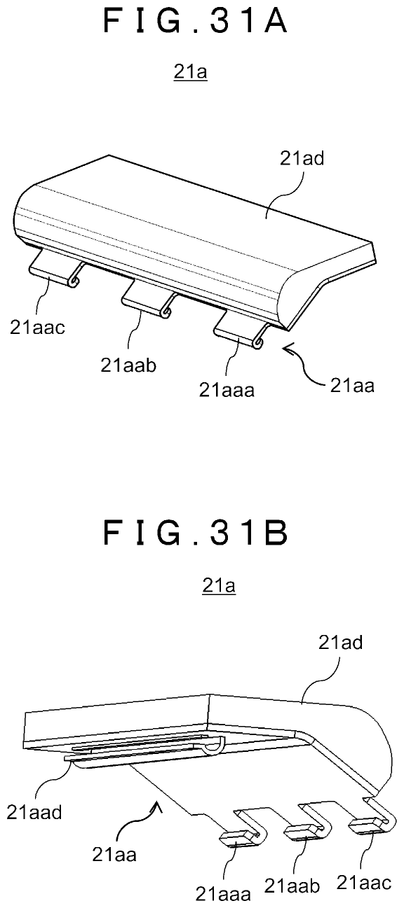

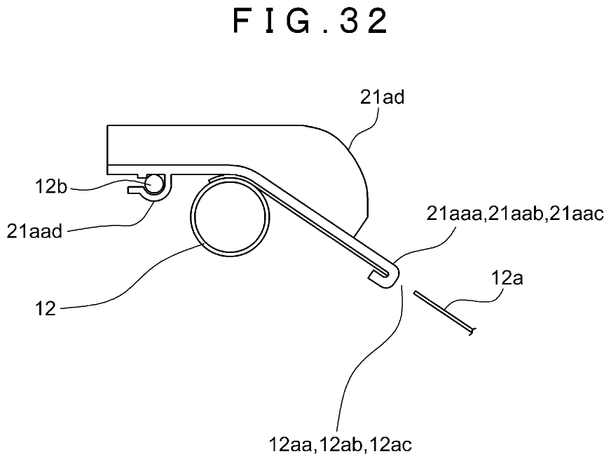

Next, a rear segment of the seat cushion will be described by the use of FIGS. 31A, 31B, 32. FIG. 31A is a perspective view of a front side of the rear segment of the seat cushion. FIG. 31B is a perspective view of a rear side of the rear segment of the seat cushion. FIG. 32 is a figure to illustrate a way to fit the rear segment to the seat cushion frame.

As shown in FIG. 31A, the rear segment 21a is composed of a hard panel 21aa formed of plastic and a foam part 21ad. The foam part 21ad is formed in the same way as the foam part 31ad. As shown in FIG. 31B, the hard panel 21aa has hook parts 21aaa, 21aab, 21aac, 21aad which are formed integrally with its main body. As shown in FIG. 32, the hook parts 21aaa, 21aab, 21aac are engaged with holes 12aa, 12ab, 12ac made in a metal pan 12a, and the hook part 21aad is engaged with a segment assisting wire 12b and is fixed to the seat cushion frame 12.

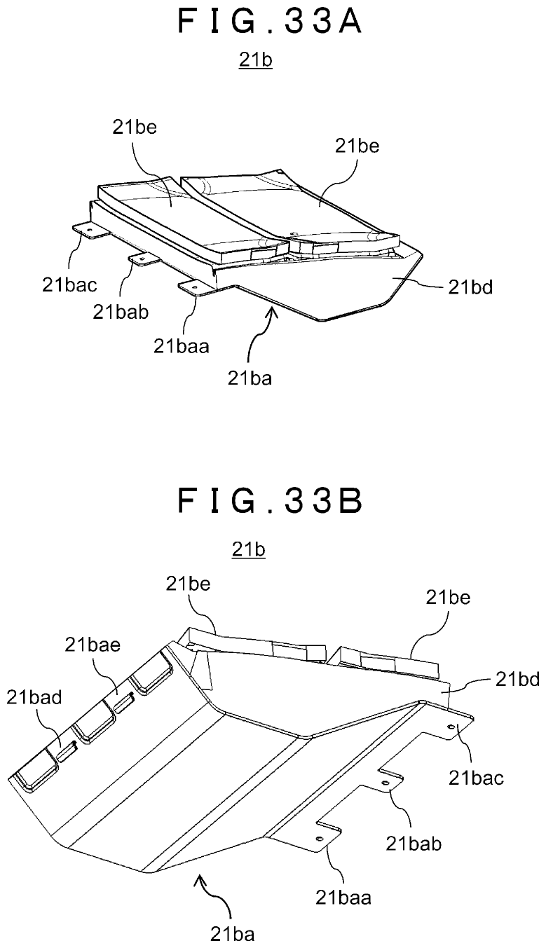

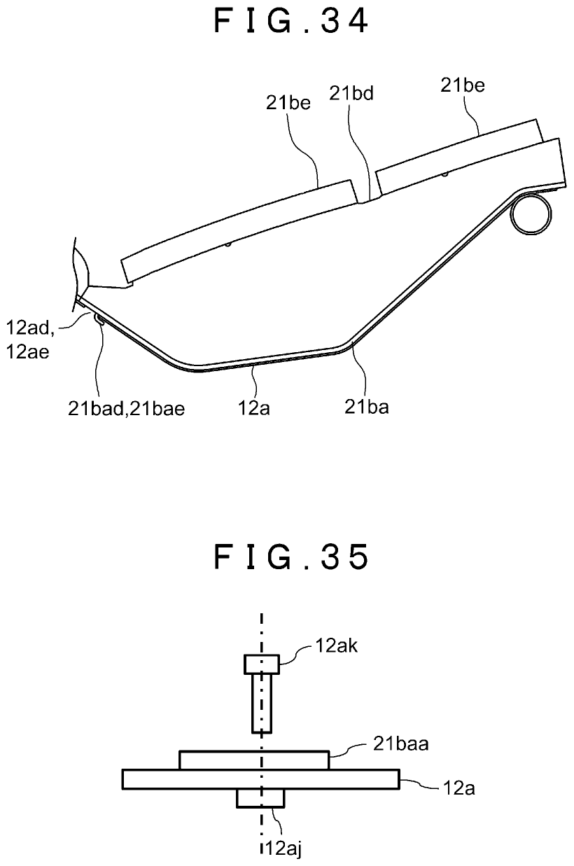

Next, a central segment of the seat cushion will be described by the use of FIGS. 33A, 33B, 34, 35. FIG. 33A is a perspective view of a front side of a central segment of the seat cushion. FIG. 33B is a perspective view of a rear side of the central segment of the seat cushion. FIG. 34 is a figure to illustrate a way to fit the central segment to the seat cushion frame. FIG. 35 is a figure to illustrate a way to fasten the central segment to the metal pan.

As shown in FIG. 33A, the central segment 31b is composed of a hard panel 21ba formed of plastic and foam parts 21bd, 21be. The foam parts 21bd, 21be are formed in the same way as the foam part 31ad. The foam part 21be is attached to a surface layer portion of the foam part 21bd so as to adjust a riding performance. The foam part 21be is a separate pad, which is called a topper pad and has a low hardness, and is used at the time of producing a soft touch feeling. Further, in a case where a harder ride quality is required, the foam part 21be may not be attached to the form part 21bd but the segment may be formed of only the foam part 21bd having a conventional hardness or a substance like a tip urethane or a styrene foam may be built in a pad to increase a hardness. As shown in FIG. 33B, the hard panel 21ba has fitting parts 21baa, 21bab, 21bac and hook parts 21bad, 21bae which are formed integrally with its main body. As shown in FIG. 34, the hook parts 21bad, 21bae are engaged with holes 12ad, 12ae of metal pan 12a, and as shown in FIG. 35, the fitting part 21baa is fixed to the seat cushion frame 12 by a nut 12aj fixedly attached to the metal pan 12a and by bolt 12ak. The fitting parts 21bab, 121bac are fixed to the seat cushion frame 12 as is the case with the fitting part 21baa.

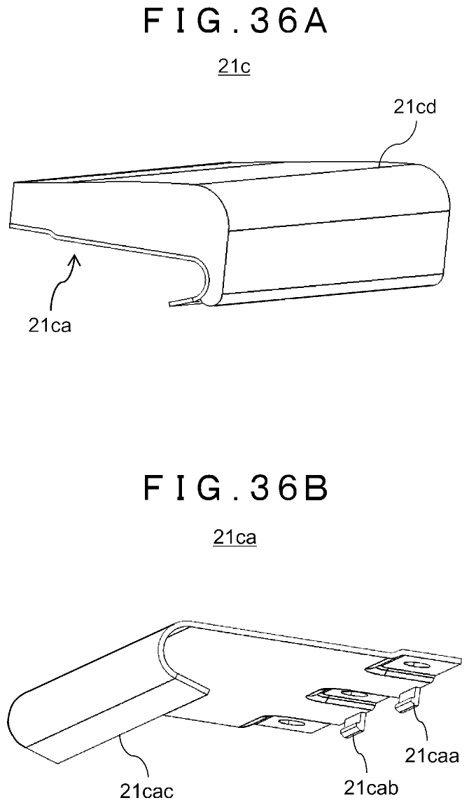

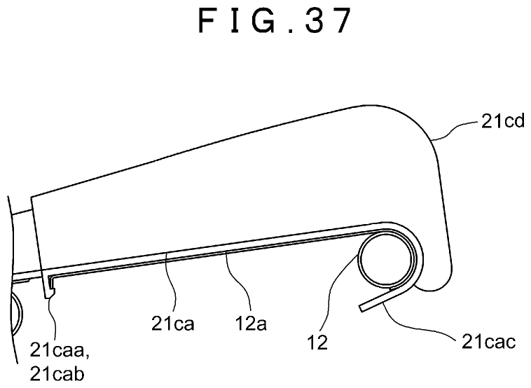

Next, a front segment of the seat cushion will be described by the use of FIGS. 36A, 36B, 37. FIG. 36A is a perspective view of a front side of the front segment of the seat cushion. FIG. 36B is a perspective view of a rear side of a hard panel of the front segment of the seat cushion. FIG. 37 is a figure to illustrate a way to fit the front segment to the seat cushion frame.

As shown in FIG. 36a, the front segment 21c is composed of a hard panel 21ca formed of plastic and a foam part 21cd. The foam part 21cd is formed in the same way as the foam part 31ad. As shown in FIG. 36B, the hard panel 21ca has snap parts 21caa, 21cab and a hook part 21cac which are formed integrally with its main body. As shown in FIG. 37, the hook part 21cac is engaged with the seat cushion frame 12, and the snap parts 21caa, 21cab are engaged with holes 12ae, 12ag of the metal pan 12a and is fixed to the seat cushion frame 12.

Respective segments of an upper segment 31a, a central segment 31b, a lower segment 31c, a left segment 31d, and a right segment 31e are fixed to each other by an bonding cloth made of nylon and having a pile-shaped fabric and a hook-shaped fabric which adhere to each other. Further, respective segments of a rear segment 21a, a central segment 21b, a front segment 21c, a left segment 21d, and a right segment 21e are fixed to each other by an bonding cloth made of nylon and having a pile-shaped fabric and a hook-shaped fabric which adhere to each other. In this regard, as is the case with the embodiment 2, these segments may not be fixed by the bonding cloth made of nylon.

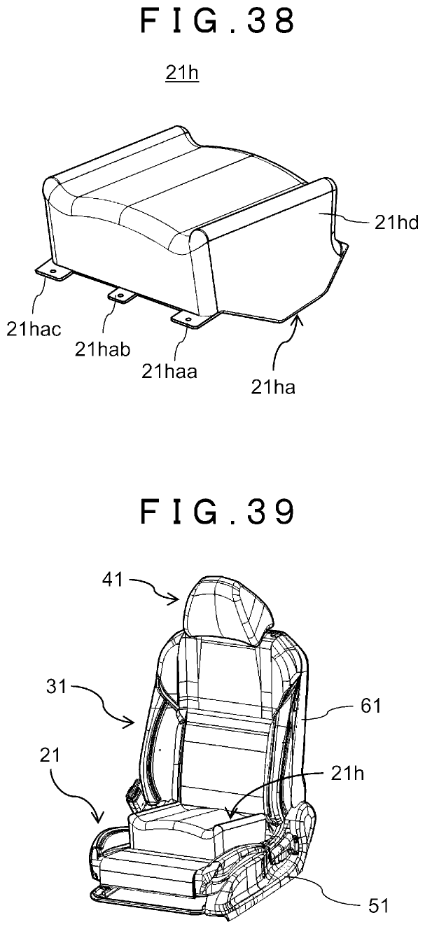

Next, a child booster seat will be described by the use of FIGS. 38, 39. FIG. 38 is a perspective view of the child booster segment. FIG. 39 is a perspective view of a vehicle seat mounted with the child booster segment.

As shown in FIG. 38, a child booster segment 21h is composed of a hard panel 21ha formed of plastic and a foam part 21hd. The hard panel 21ha is formed of the same size and shape as the hard panel 21ba of the central segment 21b and has the same fitting parts 21haa, 21hab, 21hac as the fitting parts 21baa, 21bab, 21bac and the same hook parts as the hook parts 21bad, 21bae. Hence, the child booster segment 21f can be fitted in place of the central segment 21b, and as shown in FIG. 39, the child booster segment 21h can be embedded in the seat cushion 21.

According to embodiments, each segment can be replaced, so only a segment of a part which is to be highly worn such as the side part on the outside can be also replaced at low cost and easily. Further, the segments can be easily removed and fitted (replaced). Still further, a shape, a hardness, and a kind of material of a surface of each segment (including a child booster) can be changed, so a ride quality and a design can be selected in accordance with a taste of a user by changing the segment or a combination of the segments.

Up to this point, the invention made by the present inventor has been described specifically on the basis of embodiments. However, it is needless to say that the present invention is not limited to the embodiments described above but can be variously modified.

What is claimed is:

1. A vehicle seat comprising:
a seat cushion frame;
a seat back frame;
a seat cushion main part that is fitted to the seat cushion frame;
a seat cushion side part that is arranged on a side portion of the seat cushion main part and that is fitted to the seat cushion frame;
a seat back main part that is fitted to the seat back frame; and
a seat back side part that is arranged on a side portion of the seat back main part and that is fitted to the seat back frame,
wherein each of the seat cushion main part and the seat back main part is composed of a plurality of segments,
wherein each segment has a foam part, and
wherein the foam part is separated from the foam part of the other segment.

2. The vehicle seat according to claim 1,
wherein the seat cushion main part is provided with a front segment, a central segment, and a rear segment,
wherein the seat back main part is provided with an upper segment, a central segment, and a rear segment,
wherein the seat cushion side part is provided with a left segment and a right segment, and
wherein the seat back side part is provided with a left segment and a right segment.

3. The vehicle seat according to claim 2, further comprising:
an assisting bracket that is fixedly attached to the seat cushion frame; and
an assisting bracket that is fixedly attached to the seat back frame,
wherein each segment of the seat cushion side part has a hard panel that is fitted to the assisting bracket of the seat cushion frame, and
wherein each segment of the seat back side part has a hard panel that is fitted to the assisting bracket of the seat back frame.

4. The vehicle seat according to claim 3, further comprising:
a bolt and a nut that fix the hard panel of the seat cushion side part and the assisting bracket of the seat cushion frame; and
a bolt or stud and a nut that fix the hard panel of the seat back side part and the assisting bracket of the seat back frame.

5. The vehicle seat according to claim 2, further comprising:
a seat cushion pan that is fixedly attached to the seat cushion frame; and
an assisting bracket that is fixedly attached to the seat cushion frame,
wherein the seat cushion main part is provided with a hard panel that is fitted to the assisting bracket of the seat cushion frame or to the seat cushion pan.

6. The vehicle seat according to claim 5, further comprising:
a bolt and a nut that fix the hard panel of the seat cushion main part and the assisting bracket of the seat cushion frame; and
a bolt and a nut that fix the hard panel of the seat cushion main part and the seat cushion pan.

7. The vehicle seat according to claim 4, further comprising:
a seat cushion pan that is fixedly attached to the seat cushion frame; and
an assisting bracket that is fixedly attached to the seat cushion frame,
wherein each segment of the seat cushion main part is provided with a hard panel that is fitted to the assisting bracket of the seat cushion frame or to the seat cushion pan.

8. The vehicle seat according to claim 7, further comprising:
a bolt and a nut that fix the hard panel of the seat cushion main part and the assisting bracket of the seat cushion frame; and
a bolt and a nut that fix the hard panel of the seat cushion main part and the seat cushion pan.

9. The vehicle seat according to claim 2, further comprising:
an assisting bracket that is fixedly attached to the seat back frame; and
a suspension mat,
wherein each segment of the seat back main part is provided with a hard panel that is fitted to the assisting bracket of the seat back frame or to the suspension mat.

10. The vehicle seat according to claim 9, further comprising:
a bolt and a nut that fix the hard panel of the seat back main part and the assisting bracket of the seat back frame, and
a stud and a nut that fix the hard panel of the seat back main part and the suspension mat.

11. The vehicle seat according to claim 2, further comprising:
an assisting bracket that is fixedly attached to the seat back frame; and
an assisting wire that is fixedly attached to the seat back frame,
wherein each segment of the seat cushion main part is provided with a hard panel that is fitted to the assisting bracket of the seat cushion frame or to the assisting wire.

12. The vehicle seat according to claim 11, further comprising:
a bolt and a nut that fix the hard panel of the seat back main part and the assisting bracket of the seat back frame.

13. A method of manufacturing a vehicle seat, the method comprising:
a step of preparing a seat frame that is provided with a seat cushion frame and a seat back frame;
a step of preparing a front segment, a central segment, a rear segment, a left segment, and a right segment of a seat cushion in such a way that these segments are separated from each other;
a step of preparing an upper segment, a central segment, a lower segment, a left segment, and a right segment of a seat back in such a way that these segments are separated from each other;
a step of fitting the front segment, the central segment, the rear segment, the left segment, and the right segment of the seat cushion to the seat cushion frame; and
a step of fitting the upper segment, the front segment, the central segment, the lower segment, the left segment, and the right segment of the seat back to the seat back frame,
wherein each segment of the front segment, the central segment, the rear segment, the left segment, and the right segment of the seat cushion is provided with a foam part on which a seated person abuts, and
wherein each segment of the upper segment, the central segment, the lower segment, the left segment, and the right segment of the seat back is provided with a foam part on which a seated person abuts.

14. The method of manufacturing a vehicle seat according to claim 13,
wherein each segment of the left segment and the right segment of the seat cushion has a fitting part, and wherein the fitting part is fixed to the seat cushion frame by a nut and a bolt, and
wherein each segment of the left segment and the right segment of the seat back has a fitting part, and wherein the fitting part is fixed to the seat back frame by a nut and a bolt or a stud.

15. The method of manufacturing a vehicle seat according to claim 13,
wherein each segment of the front segment, the central segment, and the rear segment of the seat cushion has a fitting part, and
wherein the fitting part is fixed to the seat cushion pan that is fixedly attached to the seat cushion frame and an assisting bracket by a nut and a bolt or a stud.

16. The method of manufacturing a vehicle seat according to claim 13,
wherein each segment of the upper segment, the central segment, and the lower segment of the seat back has a fitting part, and
wherein the fitting part is fixed to the seat back frame or a cushion mat by a nut and a bolt or a stud.

17. The method of manufacturing a vehicle seat according to claim 13,
wherein each segment of the front segment, the central segment, and the rear segment of the seat cushion has a fitting part, and
wherein the fitting part is fixed to the seat cushion pan that is fixedly attached to the seat cushion frame or an assisting bracket by a nut and a bolt.

18. The method of manufacturing a vehicle seat according to claim 13,
wherein each segment of the upper segment, the central segment, and the lower segment of the seat cushion has a fitting part, and
wherein the fitting part is fixed to the seat back frame or an assisting wire by a nut and a bolt.
